(19) United States
(12) Patent Application Publication
(10) Pub. No.: US 2005/0165543 A1
(43) Pub. Date: Jul. 28, 2005

(54) Display method and apparatus for navigation system incorporating time difference at destination

(76) Inventor: Tatsuo Yokota, Torrance, CA (US)

Correspondence Address: MURAMATSU & ASSOCIATES;Suite 225, 7700 Irvine Center Drive, Irvine, CA, 92618, US

(21) Appl. No.: 10/762,793

(22) Filed: Jan. 22, 2004

(51) Int. Cl. G01C 21/26

(52) U.S. Cl. 701/204; 340/995.1; 701/200

(57) ABSTRACT

A display method and apparatus for a navigation system calculates and displays an estimated time of arrival (ETA) by a standard time at the destination and a POI (Point of Interest) open/close status at arrival, and a time zone change notice when a user crosses a boundary of the time zones. The display method includes the steps of: examining a position of a destination and monitoring a current position of a user during a travel to the destination; retrieving information on time zones and observation of daylight saving time at the current user position and the destination; calculating the ETA at the destination based on a local time and daylight saving time of the destination using the retrieved information; and displaying the ETA at the destination and a current time.

### FIELD OF THE INVENTION

This invention relates to a display method and apparatus incorporating time zones and daylight saving time, and more particularly, to a display method and apparatus for a navigation system which is capable of displaying an estimated time of arrival (ETA) by a standard time at the destination and a POI (Point of Interest) open/close status at arrival, and a time zone change notice when a user crosses a boundary of the different time zones.

### BACKGROUND OF THE INVENTION

A navigation system performs travel guidance for enabling a user to easily and quickly reach the selected destination. A typical example is a vehicle navigation system. Such a navigation system detects the position of the user or user's vehicle, reads out map data pertaining to an area at the current vehicle position from a data storage medium, for example, a CD-ROM (compact disc read-only memory), a DVD (digital versatile disc), or a hard disc. Alternatively, such map data can be provided to the user from a remote server through a communication network such as Internet. The navigation system displays a map image on a monitor screen while superimposing a mark representing the current location of the user on the map image.

When a destination is set, the navigation system starts a route guidance function for setting a guided route from the start point to the destination. To determine the guided route to the destination, the navigation system calculates and determines an optimum route to the destination based on various parameters. For example, the guided route is determined based on the shortest way to reach the destination, the route preferring freeways to surface roads, the least expensive way to the destination, or the route without using toll road, and the like.

During the route guidance, the navigation system reads the nodes data from the data storage medium such as DVD and successively stores the nodes data of road segments (expressed in longitude and latitude) constituting the guided route in a memory. In the actual traveling, the node series stored in the memory is searched for a portion of the guided route to be displayed in a map display area of the monitor screen, and the portion of the guided route is highlighted so as to be discriminable from other routes. When the vehicle is within a predetermined distance of an intersection it is approaching, an intersection guidance diagram (an enlarged or highlighted intersection diagram with an arrow indicating the direction in which the vehicle is to turn at the intersection) is displayed to inform a user of the desired one of roads or directions selectable at the intersection. Such route guidance by the navigation system is also given by voice instruction.

FIGS. 1A-1H show an example of overall procedure and screen display involved in the navigation system to obtain a maneuver guidance information screen. FIG. 1A shows an example of locator map screen of the navigation system when the destination is not specified. Typically, the navigation system displays a street on which the vehicle (current vehicle position VP) is running on a map image and a name of the street. Other information such as a north pointer NP, a map scale and a current time may also be illustrated on the display screen.

An example of process for specifying a destination in the navigation system through a Point of Interest (POI) search method is shown in FIG. 1B-1F. A main menu screen such as shown in FIG. 1B displays menu items including a “Destination” menu for entering the destination. When selecting “Destination”, the navigation system displays a “Find Destination by” screen as shown in FIG. 1C for specifying an input method for selecting the destination. The “Find Destination By” screen lists various methods for selecting the destination including “Address” for specifying the city and address of the destination, “Intersection” for specifying the names of two streets which intersect with one another, and “Point of Interest (POI)” for selecting the programmed destination based on the name, category or telephone number.

When selecting, the “Point of Interest” method in FIG. 1C, the navigation system displays selection methods of point of interest (POI) either by “Place Name” or “Place Type” in FIG. 1D. The “Place Name” is to specify a name of POI, and the “Place Type” is to specify a category of POI. If the “Place Type” is selected in FIG. 1D, the navigation system lists categories of POIs as shown in FIG. 1E. The user selects a desired category of POIs from the lists.

FIG. 1F shows a screen when the user has selected a “Fast Foods” category in the example of FIG. 1E. In this example, the screen includes the name of POI type “Fast Foods” at the top and a list of names of the fast food restaurants typically sorted by distance from the current destination. The user selects a particular restaurant among the restaurant lists for route guidance. In FIG. 1G, the navigation system calculates an optimum route to the selected destination. After determining the guided route, the navigation system starts the route guidance as shown in FIG. 1H. Typically, the navigation system shows the intersection that is highlighted to show the next turn and a direction of the turn.

FIG. 2 is an illustration showing an instance when the user is driving a car having a navigation system and is crossing a border of two states (ex. from California to Arizona) that have different time zones. The user may not be aware of the time difference between such adjacent states. Moreover, even within the same state, there may be differences in time based on county ordinances, etc. Further, some states observe the daylight saving time while other states are exempt from the daylight saving time. Thus, when a user crosses one or more borders, the user has to be familiar with the local times and time rules. However, such time systems can be relatively complicated and people usually do not pay much attention to the local times or other time differences before arriving at such time zones.

Generally, a conventional navigation system shows an estimated arrival time at the destination while guiding the user to the destination. FIGS. 3A-3H show an example of overall procedure and screen display involved in such a route guidance by the navigation system. This example shows the case where a user is making a long business trip from California (Pacific time zone) to Arizona (Mountain time zone). In order to specify the destination, the navigation system provides the user with several selection methods such as “Address”, “intersection”, “Point of Interest” and the like, which is well known in the art.

When the user specifies a destination, the “Confirm Destination” screen is displayed as shown in FIG. 3A. If the user selects “OK to Proceed” menu on the screen, the navigation system calculates a route to the destination, typically, by creating a quickest route. However, if the user wants other preference, he can choose the “Option” menu. Then, the “Customized Rote Options” screen is displayed such as shown in FIG. 3B. The list includes the “Quickest Route”, “Maximize Freeways”, “Minimize Freeways”, and “Minimize Toll Roads” menus.

Suppose that the “Maximize Freeways” menu is selected in FIG. 3B, the navigation system calculates the route with the maximize freeways method. During the calculation, the “Maximize Freeways Method” screen is displayed such as shown in FIG. 3C and a progressing bar may be indicated. After finishing the calculation, the navigation system displays a “Destination Map” screen shown in FIG. 3D to show the entire route to the destination. The bold line between the current vehicle position 24a and the destination 24b is the calculated route. This screen may also show the distance 24c to the destination 24b.

When the vehicle approaches an intersection at which the driver is to make a turn, the navigation system automatically displays the intersection guidance diagrams such as shown in FIGS. 3E-3G. Typically, in addition to the route guidance on the map image, the navigation system also provides voice guidance. The screen in FIG. 3E shows that the vehicle is running on “Gateway Street”, and the present time is 10:45. The screen also shows that a distance to the destination is “368 miles” and an estimated time of arrival (ETA) is 16:16. The distance to the next intersection to turn is “100 feet”, so the vehicle needs to turn to the left and take “Barranca PKY”.

The intersection guidance diagram in FIG. 3F shows that the vehicle takes “Freeway I-5” at about 40 feet ahead and the direction is right. In FIG. 3G, the guidance screen shows that the vehicle leaves “Freeway AZ-202 Loop” and takes “Apache Blvd.” In this manner, the navigation system is giving the direction to the destination. When the vehicle reaches within a predetermined distance from the destination 28a, the navigation system informs the user that the destination is ahead.

As shown in FIGS. 3E-3H, typically, the current time and the estimated time of arrival (ETA) are displayed throughout the trip. In the conventional technology, however, the ETA is calculated by simply adding the travel time to the current time. Thus, in the above example, the arrival time 16:30 is expressed based on the standard time in Pacific time zone although the vehicle is now in Arizona (Mountain time zone) and has arrived at 17:30 in the Mountain time zone.

As described in the foregoing, the navigation system used today lacks an ability of detecting the difference of time zones and converting the time clock to the local time. Namely, the current time and the estimated time of arrival (ETA) are determined based on the time clock in the user's home town, i.e., the Pacific time in the above example. Therefore, the user may not recognize that the standard time in Arizona is advanced by one hour. Further, when the user travels in a summer time, the situation will be more complicated since the daylight saving time may not be observed by certain states or regions of the states.

Therefore, the user will be confused in such situations where both the time zones and daylight saving time are involved. Consequently, the user may not be able to accomplish the purpose of the trip because of misunderstanding in the time difference between the home town and the destination. Therefore, developing a display method and apparatus to solve the above problems is an essential need for a navigation system.

### SUMMARY OF THE INVENTION

It is, therefore, an object of the present invention to provide a display method and apparatus for a navigation system which can display an estimated time of arrival (ETA) in the local time at the destination.

It is another object of the present invention to provide a display method and apparatus for a navigation system which is able to show an open or close status or degrees of remaining business hours of points of interest (POI) when a user arrives at the destination.

It is a further object of the present invention to provide a display method and apparatus for a navigation system which is able to check the business hours of POIs in the destination area based on the local time of the destination and lists the POIs with icons showing remaining business hours of POIs at the time of arrival.

It is a further object of the present invention to provide a notice indicating a change in the time zone when a user approaches or crosses the boundary of two or more different time zones.

It is a further object of the present invention to provide various examples of display screen to notify the time zone change and prompt the user to select the desired local time to be displayed.

In the present invention, the navigation system monitors the current user position and examines the information regarding the time zones and daylight saving time in the destination and current position. Based on the time information, the navigation system displays the estimated arrival time based on the local time of the destination. The navigation system also checks the business hour of the destination and displays an open/close status of the destination at arrival.

More specifically, the display method of the present invention includes the steps of: examining a position of a destination and monitoring a current position of a user during a travel to the destination; retrieving information on time zones and observation of daylight saving time at the current user position and the destination; calculating an estimated time of arrival (ETA) at the destination based on the standard time and daylight saving time of the destination using the retrieved information; and displaying the ETA at the destination and a current time.

Preferably, when the destination is a POI (point of interest), the display method includes a step of retrieving business hour information of the destination POI, and a step of displaying the ETA includes a step of displaying the business hour of the destination. The process may further includes a step of displaying the business hours of other POIs in the neighborhood of the destination. Preferably, the display method also includes a step of display an open/close status of the destination POI.

In a further aspect, the display method further includes the steps of specifying a type or name of POIs in a neighborhood area of the destination from a POI database of the navigation system, retrieving business hour information of the POIs from the POI database or from a remote service provider through a wireless communication, and comparing the ETA at the destination and the business hour information of the POIs and informing estimated open/close states of the POIs at a time of arrival at the destination.

In a further aspect, the display method further includes the steps of specifying a type of POIs in a neighborhood area of the destination from a POI database of the navigation system, retrieving business hour information of the specified type of POIs from the POI database or from a remote service provider through a wireless communication, comparing the ETA at the destination and the business hour information of the POIs, and listing the specified type of POIs sorted by distance from a reference location or the destination. Each POI in the list is accompanied by an estimated remaining business hour at a time of arrival at the destination. In the above aspect of the present invention, the display method lists the specified type of POIs in the neighborhood area of the destination sorted by degrees of remaining business hour at a time of arrival at the destination.

The estimated remaining business hours of the POIs in the neighborhood area of the destination sorted by distance or sorted by the degrees of remaining business hours noted above are classified and displayed by icons incorporating predetermined shapes or colors.

In a further aspect of the present invention, the display method includes a step of indicating a change of time zone when the current position is a border or near the boarder of two or more different time zones. The notice of time zone change is given without regard to whether the navigation system is in a route guidance mode for guiding the user to the destination or a mode other than the route guidance mode. The notice of time zone change is made by displaying the notice as well as voice announcement.

A further aspect of the present invention is a display apparatus for calculating and displaying the estimated time of arrival at the destination and other information by applying the standard time and daylight saving time at the destination. The display apparatus is constituted by various means for achieving the display method described above in which the time information is displayed by the local time at the destination.

According to the present invention, the display method and apparatus of the present invention enables the user to easily and correctly know the estimated arrival time at the destination by incorporating the travel time, differences in the time zones, and the daylight saving time. The estimated arrival time is calculated automatically with use of the above parameters during the trip while monitoring the current position of the user, thereby avoiding confusion caused by time differences between the states, regions within the state, etc. If the user crosses or is about to cross a boundary of two or more different zones, the navigation system detects the change of time zone and displays a notice regarding the time zone change.

Especially, the navigation system implementing this display method is helpful when an arrival time is particularly important to the user, such as going to an airport or concert, meeting at the customer's office, and the like. Thus, confusion involved in a travel to an area having a complicated clock system such as Indiana or Arizona can be prevented, and further, the user does not have to keep wondering about the exact date and time for changing the local time or daylight saving time. Further, the navigation system of the present invention is able to extract and sort POIs in the neighborhood of the destination based on degrees of remaining business hours after arrival.

### BRIEF DESCRIPTION OF THE DRAWINGS

FIGS. 1A-1H are schematic diagrams showing an example of operational process and screen display involved in the navigation system for selecting a destination.

FIG. 2 is a schematic diagram showing a situation where a user crosses a border between regions or states having different local times.

FIGS. 3A-3H are schematic diagrams showing a process and display examples of a navigation system in the conventional technology where a user travels to a destination with a different time zone.

FIG. 4 is a block diagram showing an example of structure of a vehicle navigation system for implementing the present invention.

FIGS. 5A-5B are schematic diagrams showing an example of outer appearance of a remote controller accompanied by the navigation system of FIG. 4.

FIG. 6 is a functional block diagram showing the structure of the display apparatus for displaying the time zone change and local business time, etc. on the navigation system of the present invention.

FIG. 7 is a flow chart showing the process of selecting an automatic mode or a manual mode for calculating and displaying an estimated time of arrival (ETA) incorporating the local time at the destination in accordance with the present invention.

FIGS. 8A-8E show an example of screen display of the navigation system of the present invention during the setup process noted above with reference to FIG. 7.

FIG. 9 is a flow chart showing the process of calculating and displaying the ETA incorporating the time zones and daylight saving time at the destination in accordance with the present invention.

FIG. 10 is a flow chart showing the process of displaying POI business hours and an open/close status of the POI with respect to the estimated arrival time in accordance with the present invention.

FIG. 11 is a flow chart showing the process of monitoring the current position of the user and indicating the time change when the user is crossing a border of different time zones in the present invention.

FIGS. 12A-12B are schematic diagrams showing an example of display screen of the navigation system of the present invention for indicating the current time, the estimated time of arrival, and open/close status of business of the destination at arrival, etc.

FIGS. 13 is a schematic diagram showing another example of display screen of the navigation system of the present invention for indicating the time change during the travel when the user is crossing the border.

FIGS. 14A-14B are schematic diagrams showing another example of display screen of the navigation system of the present invention for indicating the current time, the estimated time of arrival, and open/close status of business of the destination at arrival, etc.

FIGS. 15A-15D are schematic diagrams showing examples of display screen of the navigation system of the present invention for searching POIs (points of interest) sorted by distance from a location of the destination with icons of available business hours.

FIGS. 16A-16D are schematic diagrams showing examples of display screen of the navigation system of the present invention for searching POIs (points of interest) sorted by degrees of remaining business hours.

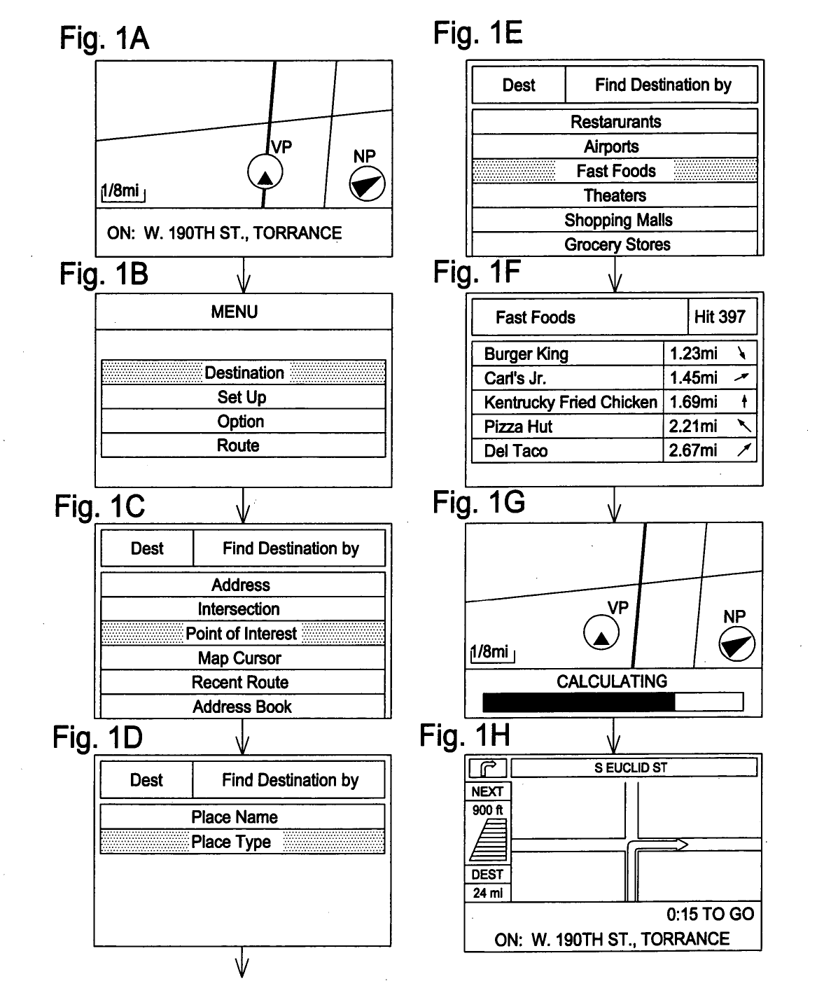

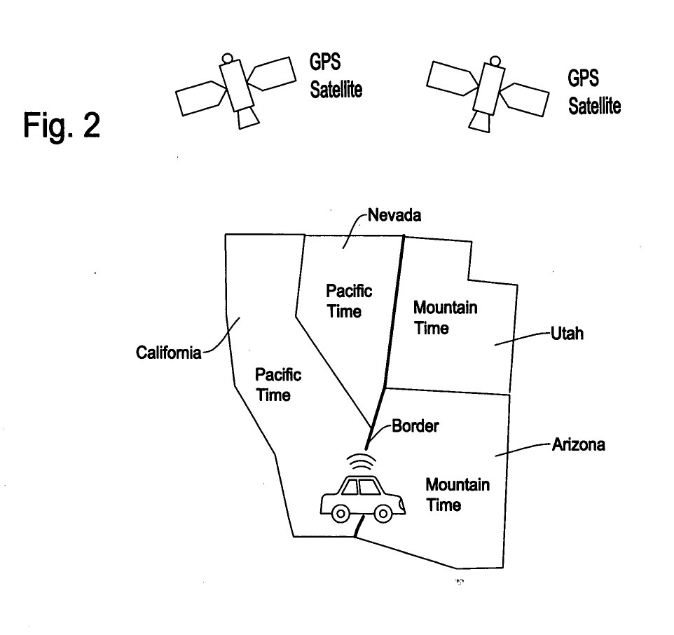

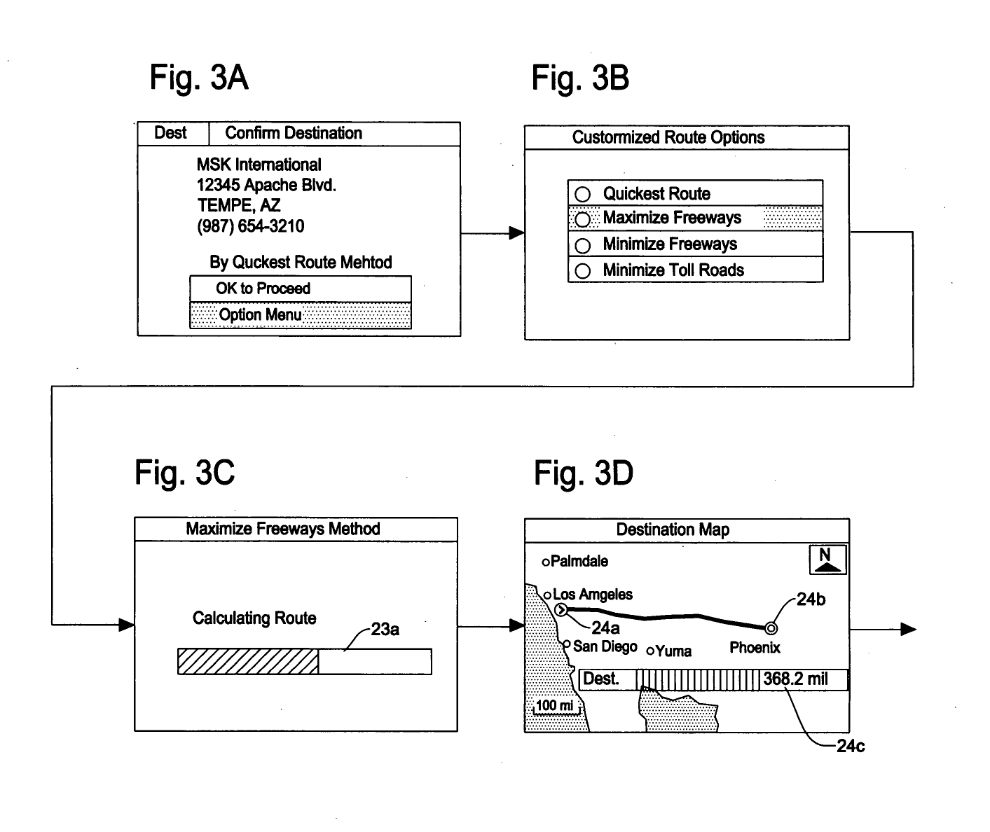

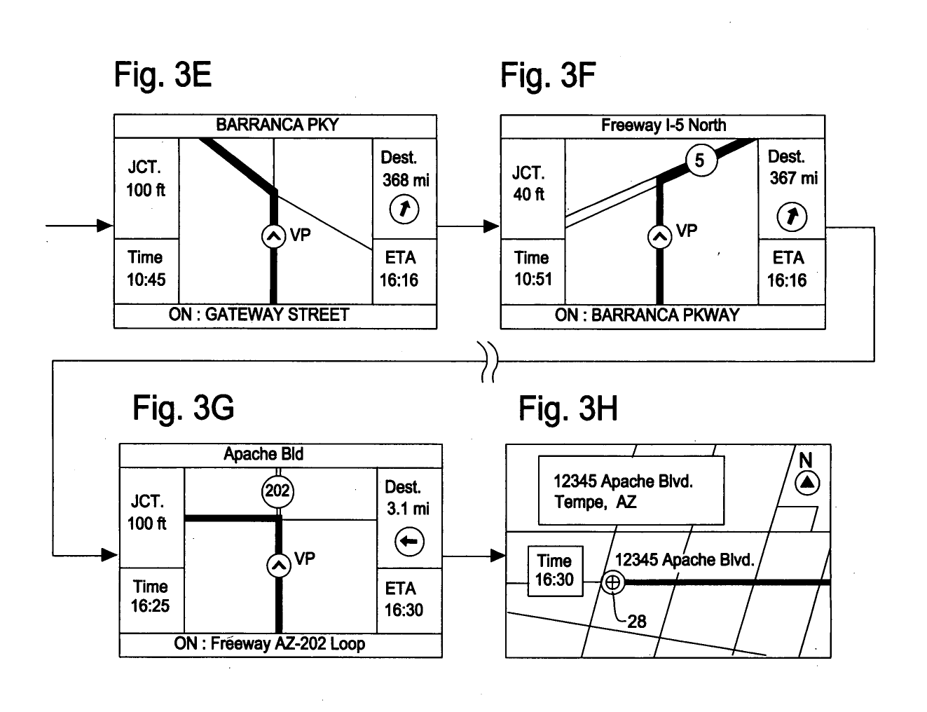

### DETAILED DESCRIPTION OF THE INVENTION

The navigation method and system of the present invention will be described in detail with reference to the accompanying drawings. The navigation system in the present invention utilizes information of time zones and daylight saving time which are stored in a map data storage such as a hard disc, CD-ROM, or DVD (digital versatile disc). Such time information can also be provided from a remote service provider through a wireless communication system or a public telephone network.

The navigation system monitors the current user position and examines the information regarding the time zones and daylight saving time in the destination and current position. Based on the time information, the navigation system displays the estimated time of arrival based on the local time of the destination. The navigation system also checks the business hour of the destination and displays an open/close status of the destination or the businesses at arrival. The navigation system also searches and sorts points of interest (POIs) in an surrounding area of the destination based on distance from a reference location such as the destination including information of business hour. In a further aspect, the navigation system searches and sort POIs in the surrounding area of the destination based on degrees of remaining business hours when the user arrived at the destination.

In general, there are nine time zones in the U.S., and the contiguous U.S. continent is divided into four time zones: Pacific, Mountain, Central and Eastern. A daylight saving time, which is also called a “summer time” is used to save energy by keeping the time one hour ahead of the standard in a summer season. Although the daylight saving time is observed in most states, it is not used in majority of Indiana state in the Eastern time zone and Arizona state in Mountain time zone. Especially, in Indiana state, time difference changes seasonably because the daylight saving time is observed in a few locals, which do not match the time zone boundaries.

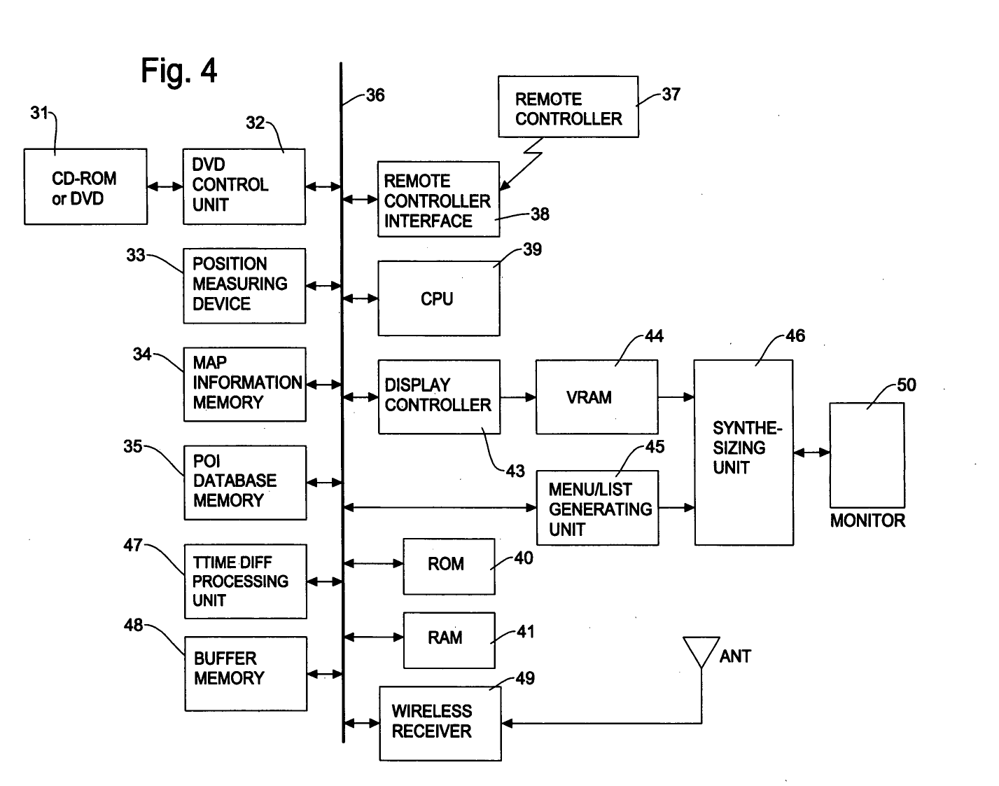

In the present invention, it is assumed that the map data storage (ex. DVD, hard disc) 31 in FIG. 4 stores the map information including the time zones and the daylight saving time corresponding to each region and state of the country. Within the context of the present invention, a term “standard time” represents a local time during the season other than the daylight saving time is applied. As noted above, the daylight saving time is used in the summer season by advancing the clock by one hour. Therefore, the “standard time” is a local time determined by the time zone of a particular area without applying the daylight saving time.

FIG. 4 shows a structure of the vehicle navigation system for implementing the present invention. While the vehicle navigation system is explained for an illustration purpose, the present invention can also be applied to other types of navigation system such as a portable navigation device implemented by a lap-top computer, a PDA (personal digital assistant), or other hand-held devices.

In the block diagram of FIG. 4, the navigation system includes a map storage medium 31 such as a CD-ROM, DVD, hard disc or other storage means (Hereafter “DVD”) for storing map information, a DVD control unit 32 for a controlling an operation for reading the map information from the DVD, a position measuring device 33 for measuring the present vehicle position. Besides the map information, the DVD 31 contains the information regarding time zones and Daylight Saving Time regions, and further contains point of interest (POI) information with business hours of POIs for use in the present invention. The position measuring device 33 is to detect a current position of the user and has a vehicle speed sensor for detecting a moving distance, a gyroscope for detecting a moving direction, a microprocessor for calculating a position, a GPS receiver, and etc.

The block diagram of FIG. 4 further includes a map information memory 34 for storing the map information which is read out from the DVD 31, a database memory 35 for storing database information such as point of interest (POI) information which is read out from the DVD 31, a remote controller 37 is used for executing a menu selection operation, an enlarge/reduce operation, a destination input operation, etc. and a remote controller interface 38.

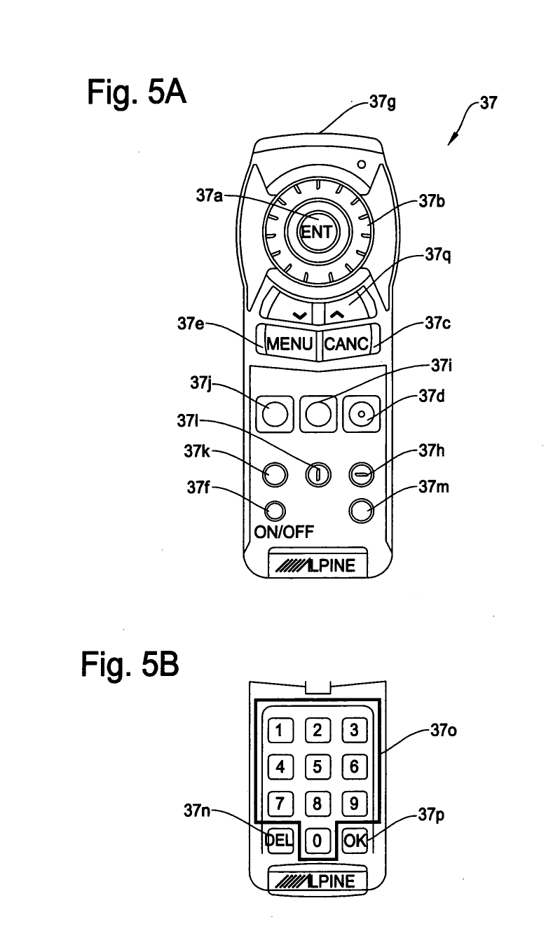

The remote controller 37 has a variety of function keys as shown in FIG. 5A and numeric keys as shown in FIG. 5B. The numeric keys appear when a lid in the lower part of FIG. 4A is opened. The remote controller 37 includes a joystick/enter key 37a, a rotary encoder 37b, a cancel key 37c, an MP/RG key 37d, a menu key 37e, a zoom/scroll key 37q, a monitor ON/OFF key 37f, a remote control transmitter 37g, a plan key 37h, an N/H key 37i, a voice key 37j, a list key 37k, a detour key 371, a delete destination key 37m, a delete key 37n, numeric keys 37o, and an OK key 37p.

The joystick/enter key 37a selects highlighted items within the menu and moves map displays and a vehicle position icon. The rotary encoder 37b changes zoom scale, scrolls list pages, moves the cursor, and etc. The cancel key 37c cancels the present displayed screen or is operated when returning the screen to the previous menu screen. The MP/RG key 37d toggles between detailed map display and basic guide display during guidance. The menu key 37e displays the main menu. The plan key 37h starts route guidance for two or more destinations for a day, the N/H key 37i changes between north-up and heading-up orientation, and the voice key 37j initiates voice instruction.

Although a remote controller such as described above is a typical example for selecting menus, executing selected unctions and etc., the navigation system includes various other input methods to achieve the same and similar operations done through the remote controller. For example, the navigation system may include hard keys and a joystick on a head unit of the navigation system mounted on a dash board, touch screen of the display panel, and voice communication means.

Referring back to FIG. 4, the navigation system further includes a bus 36 for interfacing the above units in the system, a processor (CPU) 39 for controlling an overall operation of the navigation system, a ROM 40 for storing various control programs such as a route search program and a map matching program necessary for navigation control, a RAM 41 for storing a processing result such as a guide route, a voice interface and guiding unit 42 for voice communication interface and spoken instructions, a display controller 43 for generating map image (a map guide image and an arrow guide image) on the basis of the map information, a VRAM 44 for storing images generated by the display controller, a menu/list generating unit 45 for generating menu image/various list images, a synthesizing unit 45, a time difference processing unit 47, a buffer memory 48, a wireless receiver 49, and a monitor (display) 50.

A time difference processing unit 47 controls an overall operation of extracting and displaying a current time and an estimated time of arrival (ETA) using the local time and the daylight saving time in the present invention. During a travel, every time when the user is crossing a border of two or more regions with different local times, the navigation system displays or otherwise announces the time change so that the user is informed of the time change at each region. Preferably, a buffer memory 49 will be used to temporarily store the data regarding the time zone and daylight saving time at the regions to calculate the current time, estimated arrival time, business hours, etc.

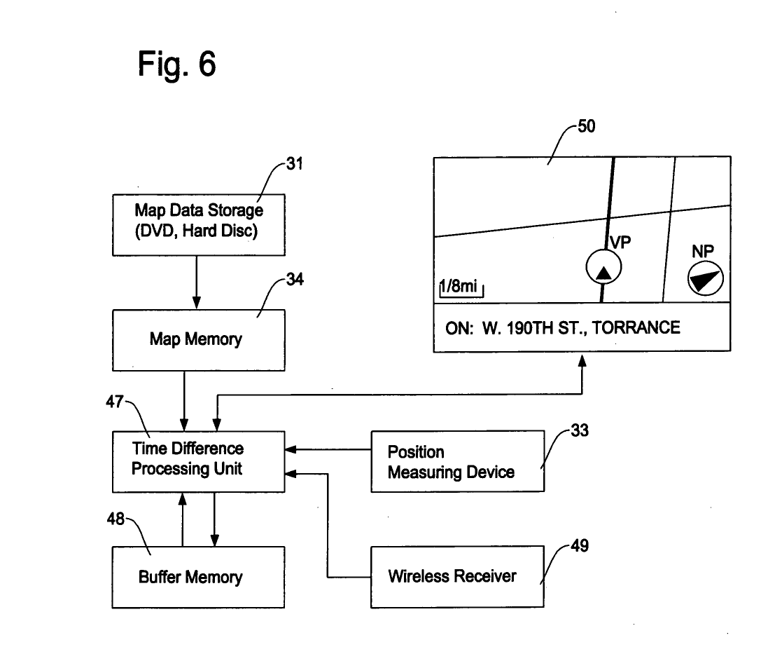

FIG. 6 shows an example of simplified structure of the navigation apparatus for calculating and displaying the time change, present time at the location of the user, estimated arrival time, etc., in the present invention. In this block diagram, the components in the block diagram of FIG. 4 which are directly involved in the operation of the present invention are shown for illustrating the basic structure of the present invention. The navigation apparatus of FIG. 6 includes a map data storage 31 such as a DVD or hard disc, a map memory 34, a time difference processing unit 47, a buffer memory 48, a wireless receiver 49, and a monitor 50.

The map data storage 31 stores the map information encompassing, for example, all over the country including time zones and daylight saving time, and any other time systems in each region. The map memory 34 extracts the map information from the map data storage 31 repeatedly by an amount necessary when traveling along the route. The map information is displayed on the monitor 50 during the travel either when the navigation system is in the route guidance mode or other than the route guidance mode.

When the destination is specified or when the position data indicating the current position is received, the time difference processing unit 47 checks if there is any difference in the time at the current position, an upcoming region, or the destination. If there is a difference in time, the time difference processing unit 47 calculates the time difference based on the time zone and daylight saving time. The time difference processing unit 47 applies the result to the estimated time of arrival (ETA) and the current time at the current position. For example, in addition to the time zone and daylight saving time, the ETA is determined by the distance to the destination and the speed of the vehicle, traffic incident information, weather condition, and the like through, for example, a wireless communication using the wireless receiver 49.

The data regarding the time zone and daylight saving time at each region surrounding the routes where the user is travelling is preferably stored in the buffer memory 48. Thus, the time difference processing unit 47 repeatedly calculates the current time, ETA, business hours at the current region and the destination, etc, by using the data stored in the buffer memory 48 as well as using the conventional data such as a distance and a traffic speed. The time difference processing unit 47 sends the calculated data to the monitor 50 to display the resultant information on the navigation system.

Preferably, the display method and apparatus of the present invention employs two modes for displaying the local time; an automatic time zone mode and a manual time zone mode. The manual time zone mode enables the navigation system to always display the local time (either the standard time or the daylight saving time) of the user's home state. For example, if the user lives in California, the local time at the current vehicle position or the estimated arrival time at the destination will be always displayed based on the Pacific zone time. On the other hand, in the automatic time zone mode, the navigation system displays the local time at the current vehicle position or the estimated arrival time at the destination based on the time zone and daylight saving time of the current position or the destination.

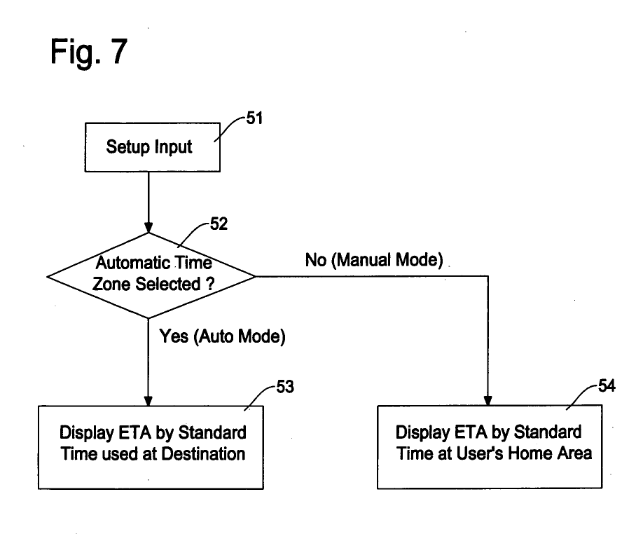

FIG. 7 is a flow chart summarizing the process for setting the time zone mode in the navigation system. First, trough a main menu screen of the navigation system, the user selects a setup menu and further selects a clock adjustment menu at step 51. In response, the navigation system displays a clock adjustment screen which includes menus for prompting the user to select a mode of either an automatic time zone or a manual time zone.

Thus, in step 52, the navigation system determines which time zone mode is selected. If the automatic time zone mode is selected, at step 53, the ETA and/or business time of destination or other POIs at the destination area will be displayed by the local time (standard time or daylight saving time) at the destination. If the manual time zone mode is selected, in step 54, the ETA and business times of POIs will be displayed based on the local time (standard time and daylight saving time) of the user's home state.

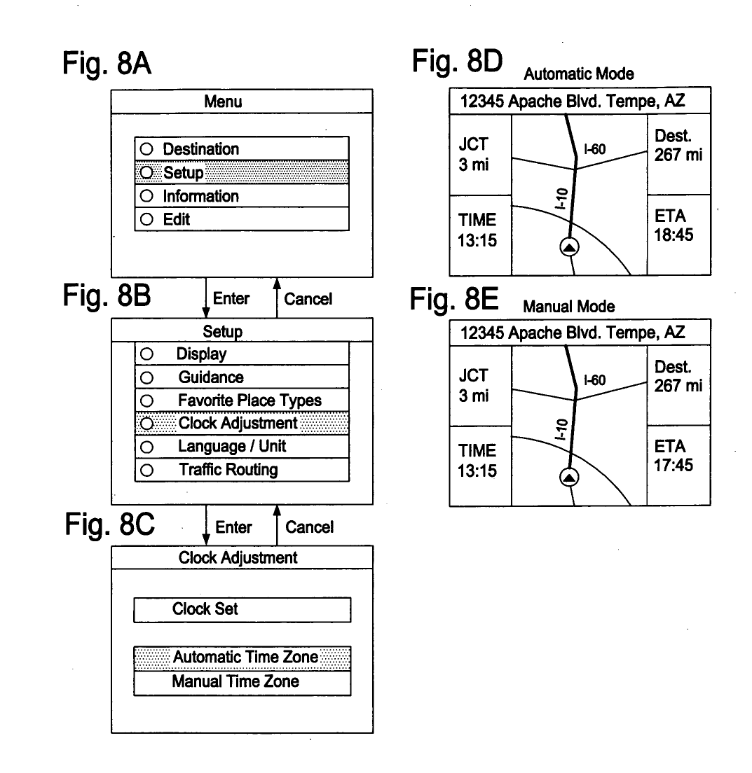

FIGS. 8A-8E show an example of screen display of the navigation system during the setup process described above with reference to the flow chart of FIG. 7. FIG. 8A shows a main menu of the navigation system in which the user selects a “Setup” menu. Then, the navigation system displays the setup screen of FIG. 8B which lists various setup items. When the user selects a “Clock Adjustment” menu, in response, the navigation system displays the clock adjustment screen of FIG. 8C. The clock adjustment screen of FIG. 8C prompts the user to select either “Automatic Time Zone” or “Manual Time Zone”.

In the case where the automatic time zone mode is selected, the navigation system calculates and displays the ETA and/or business hours of POIs at the destination area based on the local time (standard time or daylight saving time) at the destination. Thus, in FIG. 8D, the ETA is indicated as 18:45 based on the Mountain time of Arizona. If the manual time zone mode is selected, the navigation system calculates and displays the ETA and/or business hours based on the local time (standard time or daylight saving time) of the user's home state. Thus, in FIG. 8E, the ETA is indicated as 17:45 based on the time zone of the user's home state, i.e., Pacific time.

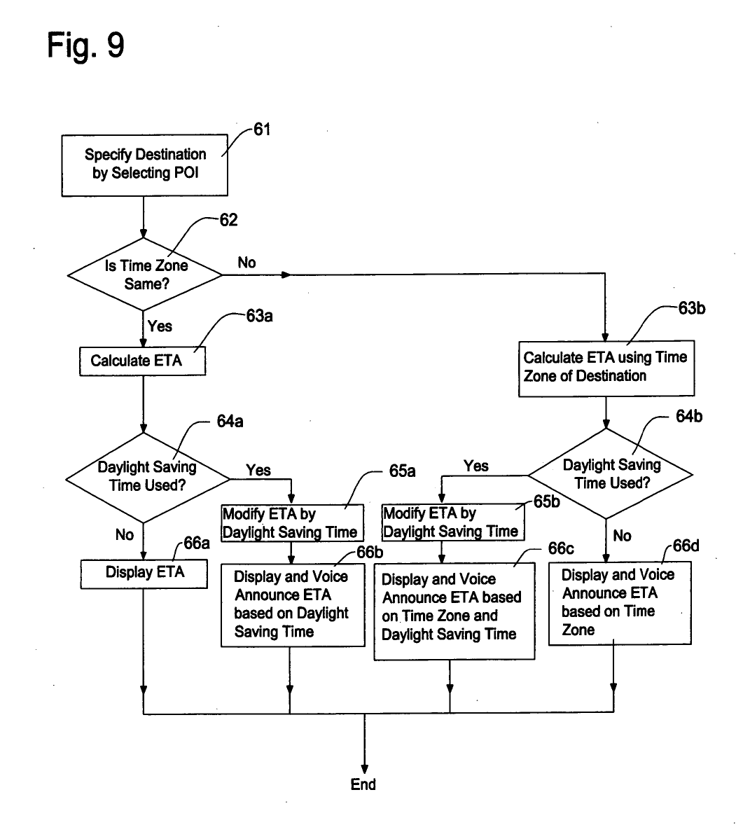

FIG. 9 is a flow chart showing the process for the navigation system to calculate and display or voice-announce the ETA information in the present invention. In order to display the ETA by the local time at the destination in the automatic time zone mode, the navigation system has to know to which time zone the destination belongs and whether the daylight saving time is observed at the destination during summer time. In the manual time zone mode, the navigation system simply calculates the ETA based on the distance to the destination, vehicle speed, traffic conditions, and other factors without considering the time zone or daylight saving time at the destination.

In the process of FIG. 9, the user first specifies the destination at step 61. Then, the navigation system checks the time zone to which the destination belongs at step 62. As noted in the foregoing, the map data storage 31 which is typically a DVD, hard disc, or CD-ROM stores the information regarding the time zone and daylight saving time. If the time zone of the destination is the same as the time zone of the user's home state or the current user (vehicle) position (hereafter “original time zone”), the navigation system calculates the ETA at the destination based on the original time zone at step 63a.

Then, when in the summer season, the navigation system further checks whether the daylight saving time is observed at the destination at step 64a. Especially, in Indiana and Arizona, there are several regions where the daylight saving time is applied while the other regions do not observe the daylight saving time. In other words, even if the destination belongs to the state with the same time zone, the daylight saving time may or may not be applied to a particular region where destination is located. If the daylight saving time is not used at the destination, the navigation system displays the ETA without applying the daylight saving time at step 66a.

If the daylight saving time is used at the destination, the navigation system will change the ETA by applying the daylight saving time at step 65a. Ordinarily, when applying the daylight saving time, the ETA is modified by advancing the time by one hour. However, in the case where the original time zone set in the navigation system has also been changed to the daylight saving time, it is unnecessary to change the ETA. Then, at step 66b, the navigation system displays, and preferably also voice announces, the ETA with notation for daylight saving time.

If the time zone at the destination is different from the original time zone, the navigation system calculates the ETA based on the local time (standard time) at the destination at step 63b. If it is in the summer time, in step 64b, the navigation system further checks whether the daylight saving time is observed at the destination. If the daylight saving time is used at the destination, at step 65b, the navigation system modifies the ETA by applying the daylight saving time. As noted above, in the case where the original time zone set in the navigation system has also been changed to the daylight saving time, it is unnecessary to change the ETA.

Then, the navigation system displays the ETA with information of the time zone and the daylight saving time at step 66c. Preferably, the navigation system also produces a voice announcement so that the user does not have see the navigation screen when driving. In the step 64b, if the navigation system detects that the daylight saving time is not used at the destination, it displays the ETA without applying the daylight saving time at step 66d which is preferably accompanied by the voice announcement.

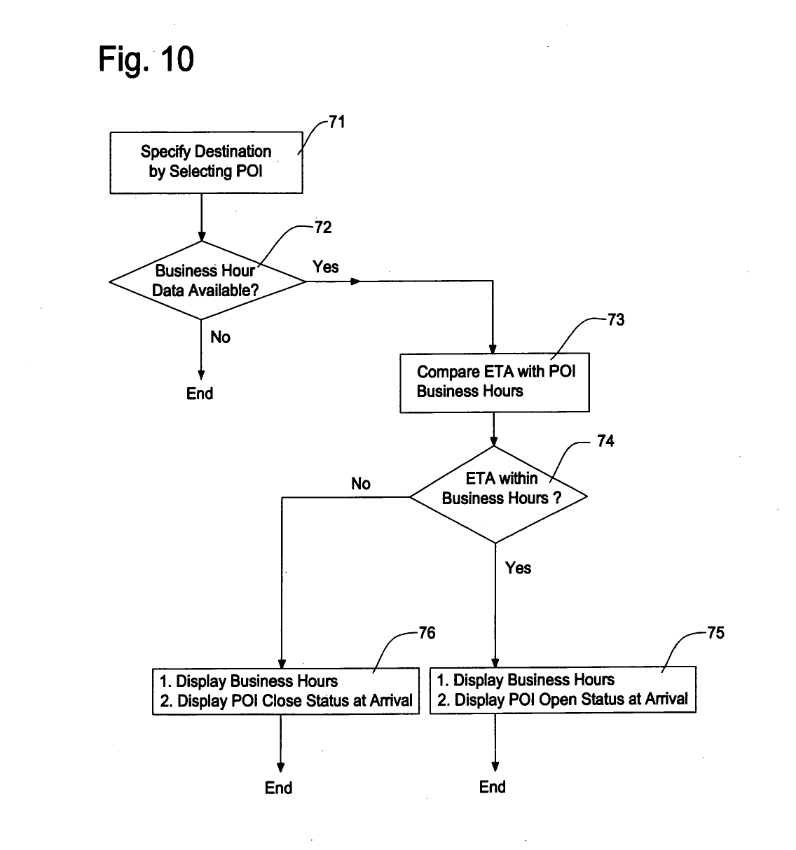

FIG. 10 is a flow chart showing an example of process for examining business hours of POIs at the destination or neighborhood thereof. The user usually wants to arrive at the destination so that he will be in time for his business plan or leisure plan at the destination. The display method and apparatus of the present invention provides the user with the information on the business hours of the destination POI or POIs in the neighborhood of the destination. In this invention, it is assumed that the map data storage 31 for the navigation system stores the business hour information of each POI. Currently, the map data storage available in the market includes the information regarding business hours of POIs although not all of POIs show such business hours.

The process of FIG. 10 detects the business hours of POIs and displays the business hours with information on open/close status at arrival. The process starts when the user inputs the destination by specifying a POI at step 71 which is detected by the navigation system. In step 72, the navigation system checks whether the business hour data of the specified POI is included in the POI database in the map data storage. If the business hour data of the POI do not exist, the process ends.

In step 72, if the information on the business hour exists in the map data storage, the navigation system compares the ETA with the business hour at step 73 and determines whether the ETA is within the business hour of the POI at step 74. If the ETA is within the business hour, the navigation system displays the ETA, business hour, and an open status of the POI in step 75. On the other hand, if the ETA is not within the business hours, the navigation system displays the ETA, business hour, and a close status of the POI at step 76.

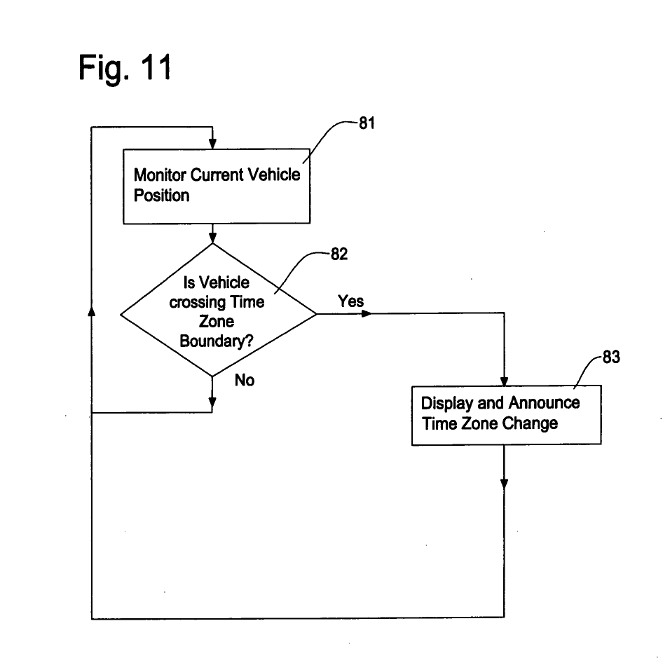

During a trip such as driving a car, riding a bike, or walking, if the user crosses or is about to cross a boundary of two or more different zones, the navigation system detects the change of time zone and displays a notice regarding the time zone change. An example of such a process for detecting and display the time zone change is shown in FIG. 11. During this operation, the position measuring device 33 (FIGS. 4 and 6) in the navigation system always monitors the current position of the user such as a vehicle position at step 81. With reference to the time zone data, the navigation system checks whether the user crosses or is going to cross the boundary of different time zones at step 82. If it is determined that the user enters or will enter a state of a different time zone, the navigation system displays a notice of time zone change at step 83 which is preferably accompanied by voice announcement.

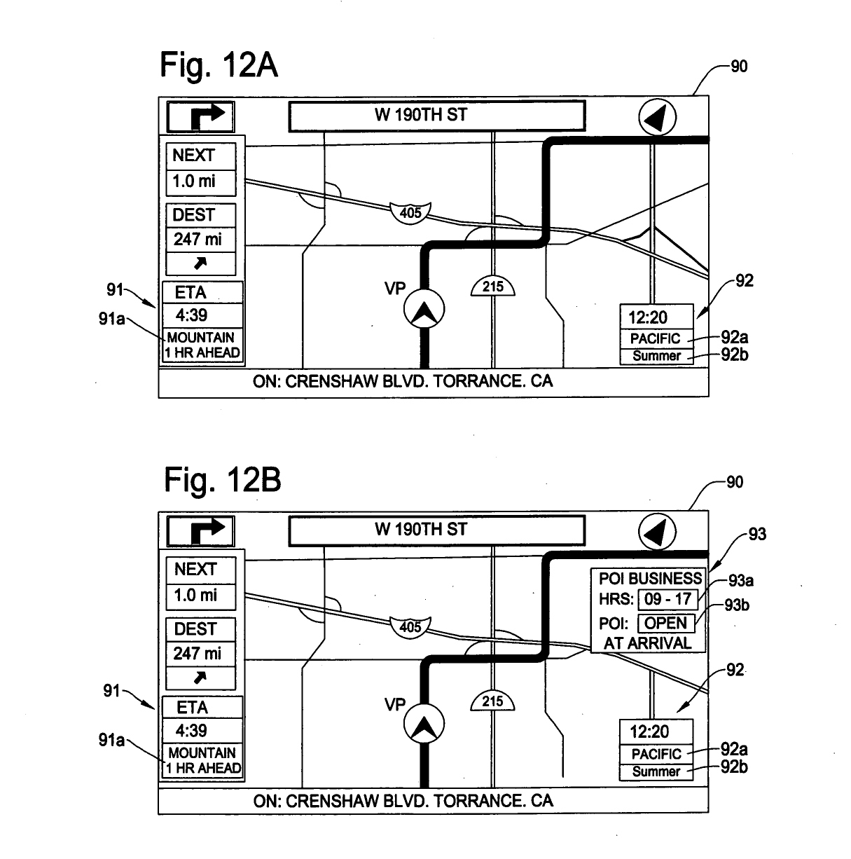

FIGS. 12A-12B, 13 and 14A-14B show examples of display screen of the navigation system involved in the processes described with reference to FIGS. 9-11. FIG. 12A shows a display screen example involved in the operation for calculating and displaying the estimated time of arrival (ETA) at the destination. As described with reference to the flow chart of FIG. 9, the navigation system modifies the current time (based on the original time zone) by the local time (standard time) in the state of the destination and the daylight saving time at the region of the destination for estimating the arrival time.

As is well known in the art, a travel time required for reaching the destination is estimated based on a distance to the destination, speed of the vehicle, various traffic conditions including accident, weather, etc. The ETA is determined by such a travel time, as well as the current time, and the data on the time zone and daylight saving time at the destination. In the example of FIG. 12A, it is assumed that the user is driving from California to Arizona, and the automatic time mode is selected (FIGS. 7 and 8A-8E). The navigation system displays a route guidance map 90 on which an ETA information box 91 accompanied by a time zone (Mountain Time) message 91a is illustrated. This example of screen also shows the current time (Pacific Time) and if applicable, daylight saving time (Summer Time). Preferably, these the messages are also given by voice announcement.

FIG. 12A is a display example in the case that the data of the POI at the destination do not contain business hour information. Therefore, no information box regarding the POI business hour is displayed in this case. The ETA is displayed by the local time (standard time or the daylight saving time) in the state in which the destination exists by for example, an ETA information box 91. The ETA information box 91 indicates the estimated time of arrival (ETA) 4:39 by the Mountain Zone time with the message 91a of “Mountain, 1 hour ahead”.

The current time is displayed based on the local time of the original time zone (user's home state, or the current user position) in a current time information box 92. The information box 92 indicates the Pacific time 92a of 12:20 and summer time 92b when the summer time is applied to the current time. In the case where the local time (standard time) at the destination is the same as that of the original time zone, the messages indicating the time zone 91a and 92a in FIG. 12A may be omitted to avoid clutter.

FIG. 12B is a display example when the destination is selected by specifying a POI name (rather than street address), and the business hour data involved in the specified POI is available. In this case, in addition to the information boxes 91 and 92 noted above, the navigation system displays a POI business information box 93 for the specified POI. In this example, this information box 93 indicates the business hour of “9-17”, and the open/close status 93b of the specified POI at ETA. If the user wants to know business hours and open/close statuses of other POIs, for example, in the neighborhood of the specified destination, he is able to receive such information by specifying such POIs in the navigation system.

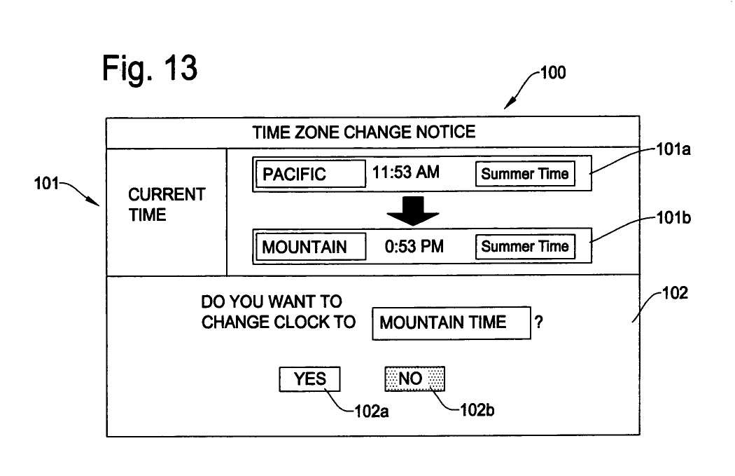

As mentioned with reference to the flow chart of FIG. 11, the navigation system of the present invention detects the current position and the border of two or more different time zones and announces the change in time zone. An example of screen display in this operation is shown in FIG. 13. The position measuring device 33 in FIG. 4 (including speed sensor, gyroscope, and GPS) in the navigation system always monitors the current user (ex. vehicle) position based on the latitude and longitude data. Therefore, when the vehicle crosses a time zone boundary, the navigation system displays the time zone change on the screen which is preferably accompanied by a voice message.

The time zone change is detected and notified regardless of whether the navigation system is in the route guidance mode or other mode such as a locator map mode. In the example of FIG. 13, the “time zone change notice” screen contains a current time information box 101. The “time zone change notice” screen also includes a selection box 102 to prompts the user to determine whether the clock should be changed to the new time zone or not.

The current time information box 101 indicates the current time 101a based on the original time zone (Pacific Time) and the time new time 101b based on the new time zone (Mountain Time). In the summer time, “Summer Time” may be displayed in the boxes 101a-101b to indicate the daylight saving time, if applicable. By selecting either a key 102a or a key 102b in a selection box 102, the user can adjust the clock of the navigation system. This selection box 102 may not be displayed in the case where the navigation system is already set to the automatic time zone mode as described above with reference to FIGS. 7 and 8A-8E.

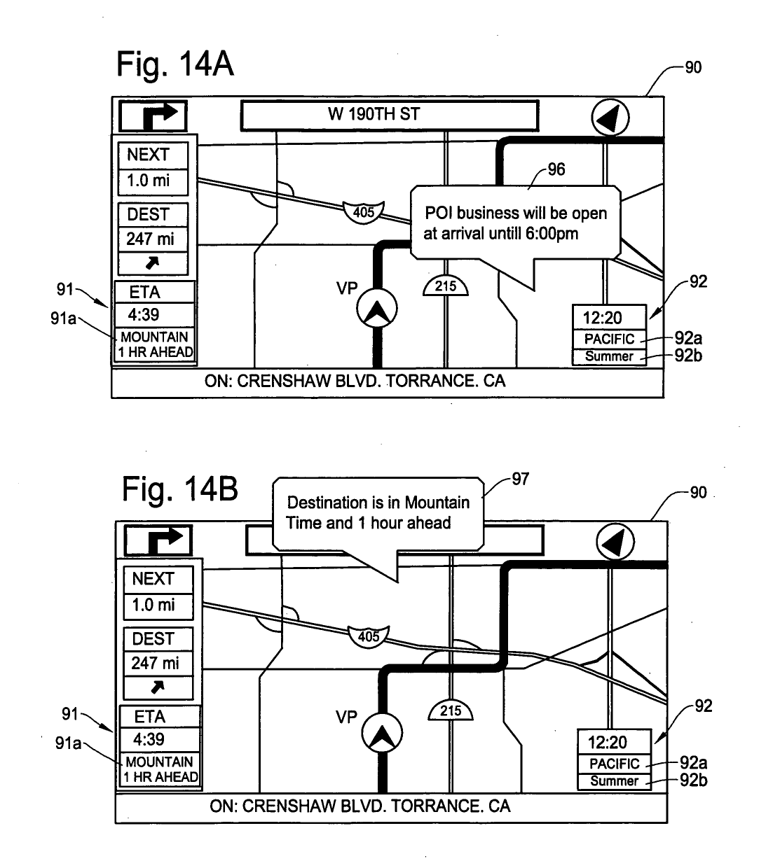

FIGS. 14A-14B show another example of time zone change and business hour of the destination in which, rather than the display example of FIGS. 12A-12B, pop-up messages are displayed on the monitor screen. The example of FIG. 14A shows a case where a balloon message 96 is displayed which indicates a business hour of the destination and open/close status of the business at arrival. The same or similar message may be preferably provided by voice announcement. The example of FIG. 14B shows a case where a balloon message 97 is displayed which indicates a time zone change when the user is crossing or about to cross the border of two or more different time zones. The same or similar message may be preferably provided by voice announcement.

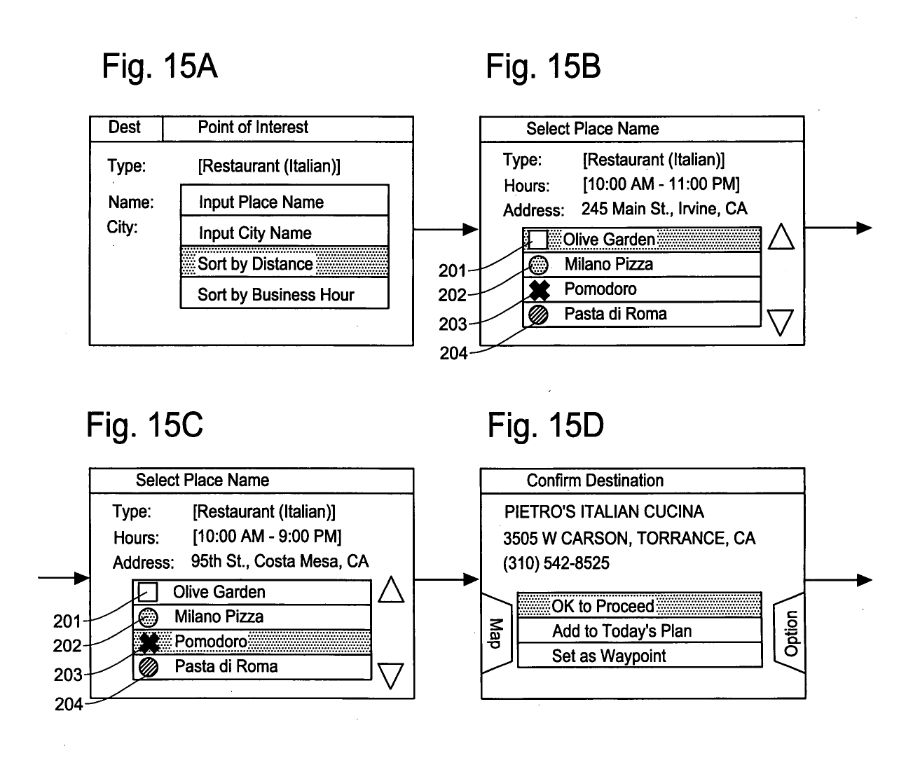

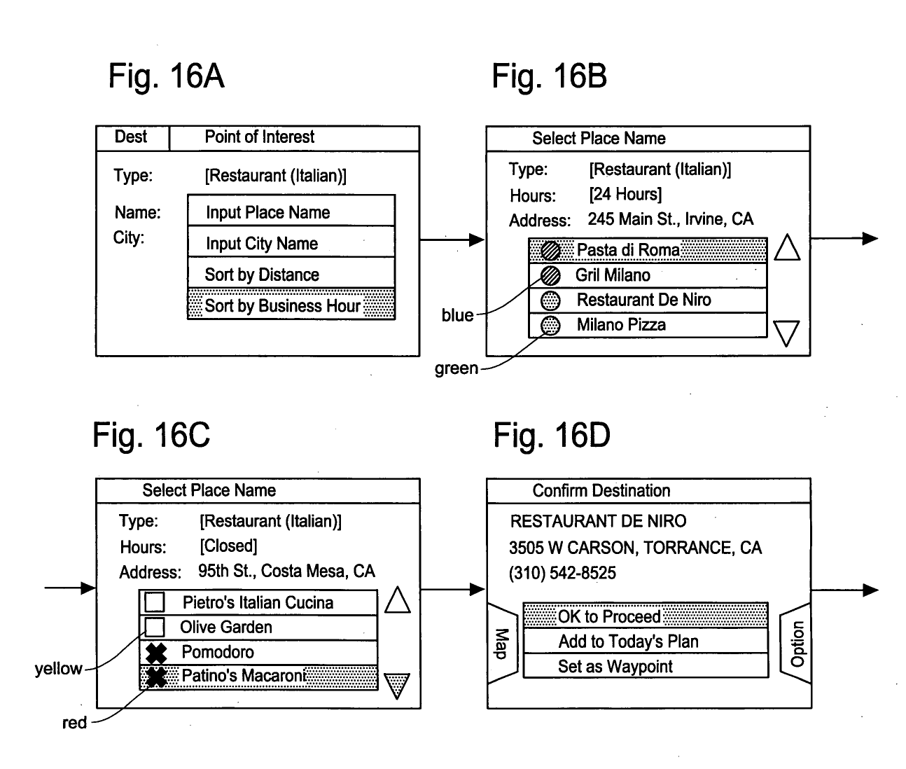

FIGS. 15A-15D and FIGS. 16A-16D show further examples for retrieving POI information in consideration of the local time in the area of the destination. FIGS. 15A-15D are schematic diagrams showing examples of display screen of the navigation system of the present invention for searching POIs sorted by distance from a reference location such as a destination with icons of available business hours. FIGS. 16A-16D are schematic diagrams showing examples of display screen of the navigation system of the present invention for searching POIs (points of interest) sorted by degrees of remaining business hours.

FIG. 15A is an example of display for prompting the user to select one of methods for searching POIs in the vicinity to a reference location such as a destination. In this example, the type of POIs to be searched is Italian restaurant. The “Sort by Distance” menu is used to search POIs in the vicinity to the destination sorted by distance from the reference location. The “Sort by Business Hour” menu is used to search POIs in the vicinity to the specified destination sorted by degree of remaining business hour.

When the user selects the “Sort by Distance” menu in FIG. 15A, the navigation system searches the type of POIs specified by the user and lists the POIs in the order of distance from a reference location, for example, the specified destination as shown in FIGS. 15B and 15C. Thus, suppose the destination is a hotel in a city in the state different from the user's home state, the navigation system lists Italian restaurants in the vicinity of the hotel in the order of distance from the hotel in consideration of the local time. In the example of FIGS. 15B and 15C, the display shows detailed information on the selected POI name.

Further in the example of FIGS. 15B and 15C, the list of POI names includes availability icons 201-204 of the POIs at the time of arrival at the destination area. The availability icons 201-204 indicate whether the POIs are available, i.e., there are remaining business hours when the user arrived at the destination. In this example, the icon 201 shows that there is a remaining business hour but is insufficient, and the icon 202 shows that there is a sufficient time, the icon 203 shows that the POI is closed, and icon 204 shows that the POI is open 24 hours a day. When the user selects one of the POI name, the navigation system confirms the selected POI and calculates a route to the selected POI for route guidance.

The screen of FIG. 16A is the same as that of FIG. 15A except that the user selects the “Sort by Business Hour” menu. Then, as shown in FIGS. 16A and 16B, the navigation system searches the type of POIs specified by the user and lists the POIs in the order of available business hour when the user arrived at a reference location, such as the destination, etc. In other words, the list is sorted by the expected duration of operation before closing time, for example, in the order from the longer duration to the shorter duration. Within POIs of the same duration, POIs will be listed in the alphabetical order or in the order of distance from the reference point in the destination area.

Further in the example of FIGS. 16B and 16C, the list of POI names includes time length icons of the POIs at the time of arrival. The time length icons can have unique shapes and/or colors to distinguish the remaining time length of the business hour of the POIs. In this example, the time length icons are assigned with colors in which blue means that the POI is open 24 hours a day, green means that the there is a sufficient remaining time (ex. one hour or more), yellow means that the remaining time is insufficient (ex. 0.5 hour or less), and red means that the POI is closed.

Since the “sufficient” or “insufficient” may vary depending on the type of establishment or the nature of business, the user can define the threshold time (filter) in the navigation system. Alternatively, such a threshold time may be preset in the navigation system so that the user does not have to set the threshold time. Rather than the icons shown in FIGS. 15B-15C and 16B-16C, the remaining business hours of the POIs may be indicated on the screen in a text form or by voice announcement.

Some facilities such as movie theaters, performing arts centers, sports stadiums, etc., operate with certain schedules unique to such facilities. For these POIs, the business hour indications mentioned above can be modified to show the relevant information. For example, the starting time of next performance or performance after next, if any, or the intermission time of a football game or concert, etc. will be displayed The relevance of information may be determined, filtered, or sorted by the estimated time of arrival and by the user preference settings.

Additionally, certain POIs require reservations or appointments. Through the wireless communication system noted above, the navigation system can be linked to the reservation management system of such POI facilities to retrieve additional information such as open time slots, available types of services on a given day, etc. In this case, the POI list can show available services and the time and duration of a particular service in addition to the facility type and name.

As has been in the foregoing, the display method and apparatus of the present invention enables the user to easily and correctly know the estimated time of arrival at the destination by incorporating the travel time, differences in the time zones, and the Daylight Saving Time. The estimated time of arrival is calculated automatically with use of the above parameters during the trip while monitoring the current position of the user, thereby avoiding confusion caused by time differences among the states, regions within the state, etc. Especially, the navigation system implementing this display method is helpful when an arrival time is particularly important to the user, such as going to the airport, concert, meeting, and the like.

Thus, confusion involved in a travel to an area having a complicated time system such as Indiana or Arizona can be prevented, and further, the user does not have to keep wondering about the exact date and time for changing the time of her home state to the local of the destination or the daylight saving time. Accordingly, the present invention reduces the possibility that the shop or theater, etc. is closed at the time of arrival due to the misunderstanding in the time difference. Further, for example, when the daylight saving time has just begun, the user would not have to rush to the airport only to realize that there is an additional hour. Furthermore, the navigation system of the present invention is able to extract and sort POIs in the neighborhood of the destination based on degrees of remaining business hours after arrival.

Although the invention is described herein with reference to the preferred embodiments, one skilled in the art will readily appreciate that various modifications and variations may be made without departing from the spirit and the scope of the present invention. Such modifications and variations are considered to be within the purview and scope of the appended claims and their equivalents.

1. A display method for a navigation system, comprising the following steps of:
examining a position of a destination and monitoring a current position of a user during a travel to the destination;
retrieving information on time zones and observation of daylight saving time at the current user position and the destination;
calculating an estimated time of arrival (ETA) at the destination based on a local time and daylight saving time of the destination using the retrieved information; and
informing the user of the ETA at the destination and a current time.

2. A display method for a navigation system as defined in claim 1, wherein said current time informed by the navigation system is produced based on a local time and daylight saving time in a time zone at the current user position or on a local time and daylight saving time in a time zone of a home state of the user.

3. A display method for a navigation system as defined in claim 1, wherein, when the destination is a POI (point of interest) selected from a POI database of the navigation system, said step of retrieving the information includes a step of retrieving business hour information of the destination POI.

4. A display method for a navigation system as defined in claim 1, wherein, when the destination is a POI (point of interest), said step of retrieving the information includes a step of retrieving business hour information of the destination POI, and said step of informing the ETA includes a step of displaying the business hour of the destination.

5. A display method for a navigation system as defined in claim 4, said step of retrieving business hour information of the destination POI includes a step of retrieving business hour information of other POIs in a neighborhood of the destination, and said step of informing the business hour of the destination includes a step of displaying the business hours of other POIs.

6. A display method for a navigation system as defined in claim 1, further comprising:
specifying a destination POI by selecting a POI (point of interest) from a POI database of the navigation system;
retrieving business hour information of the destination POI; and
comparing the ETA at the destination POI and the business hour information and informing an estimated open/close state of the destination POI at a time of arrival.

7. A display method for a navigation system as defined in claim 1, further comprising:
specifying a type or name of POIs (points of interest) in a neighborhood area of the destination from a POI database of the navigation system;
retrieving business hour information of the POIs from the POI database or from a remote service provider through a wireless communication; and
comparing the ETA at the destination and the business hour information of the POIs and informing estimated open/close states of the POIs at a time of arrival at the destination.

8. A display method for a navigation system as defined in claim 1, further comprising:
specifying a type of POIs (points of interest) in a neighborhood area of the destination from a POI database of the navigation system;
retrieving business hour information of the specified type of POIs from the POI database or from a remote service provider through a wireless communication;
comparing the ETA at the destination and the business hour information of the POIs; and
listing the specified type of POIs sorted by distance from a reference location or the destination wherein each POI in the list is accompanied by an estimated remaining business hour at a time of arrival at the destination.

9. A display method for a navigation system as defined in claim 8, wherein the estimated remaining business hours of the POIs in the neighborhood area of the destination are classified and displayed by availability icons using predetermined shapes or colors.

10. A display method for a navigation system as defined in claim 1, further comprising:
specifying a type of POIs (points of interest) in a neighborhood area of the destination from a POI database of the navigation system;
retrieving business hour information of the specified type of POIs from the POI database or from a remote service provider through a wireless communication;
comparing the ETA at the destination and the business hour information of the POIs; and
listing the specified type of POIs in the neighborhood area of the destination sorted by degrees of remaining business hour at a time of arrival at the destination.

11. A display method for a navigation system as defined in claim 10, wherein the degrees of remaining business hours of the POIs in the neighborhood area of the destination are classified and displayed by time length icons using predetermined shapes or colors.

12. A display method for a navigation system as defined in claim 1, further comprising a step of indicating a change of time zone when the current position is at a border or near the boarder of two or more different time zones.

13. A display method for a navigation system as defined in claim 12, wherein said step of indicating the time zone change includes a step of displaying the time zone change on a screen, or both displaying and voice announcing the time zone change.

14. A display method for a navigation system as defined in claim 12, wherein said step of indicating the time zone change is conducted without regard to whether the navigation system is in a route guidance mode for guiding the user to the destination or a mode other than the route guidance mode.

15. A display method for a navigation system as defined in claim 1, wherein said step of calculating the ETA includes the steps of:
calculating the ETA based on a local time at the destination if the destination belongs to a time zone different from the time zone at the current user position;
calculating the ETA based on a local time at the current user position if the destination belongs to the same time zone as the time zone at the current user position; and
compensating the ETA for a difference of daylight saving time when the daylight saving time is applied to either the destination or the current user position.

16. A display apparatus for a navigation system, comprising:
means for examining a position of a destination and monitoring a current position of a user during a travel to the destination;
means for retrieving information on time zones and observation of daylight saving time at the current user position and the destination;
means for calculating an estimated time of arrival (ETA) at the destination based on a local time and daylight saving time of the destination using the retrieved information; and
means for informing the user of the ETA at the destination and a current time.

17. A display apparatus for a navigation system as defined in claim 16, wherein said current time informed by the navigation system is produced based on a local time and daylight saving time in a time zone at the current user position or on a local time and daylight saving time in a time zone of a home state of the user.

18. A display apparatus for a navigation system as defined in claim 16, wherein, when the destination is a POI (point of interest) selected from a POI database of the navigation system, said means for retrieving the information includes means for retrieving business hour information of the destination POI.

19. A display apparatus for a navigation system as defined in claim 16, wherein, when the destination is a POI (point of interest), said means for retrieving the information includes means for retrieving business hour information of the destination POI, and said means for informing the ETA includes means for displaying the business hour of the destination.

20. A display apparatus for a navigation system as defined in claim 19, said means for retrieving business hour information of the destination POI includes means for retrieving business hour information of other POIs in a neighborhood of the destination, and said means for informing the business hour of the destination includes means for displaying the business hours of other POIs.

21. A display apparatus for a navigation system as defined in claim 16, further comprising:
means for specifying a destination POI by selecting a POI (point of interest) from a POI database of the navigation system;
means for retrieving business hour information of the destination POI; and
means for comparing the ETA at the destination POI and the business hour information and informing an estimated open/close state of the destination POI at a time of arrival.

22. A display apparatus for a navigation system- as defined in claim 16, further comprising:
means for specifying a type or name of POIs (points of interest) in a neighborhood area of the destination from a POI database of the navigation system,;
means for retrieving business hour information of the POIs from the POI database or from a remote service provider through a wireless communication; and
means for comparing the ETA at the destination and the business hour information of the POIs and informing estimated open/close states of the POIs at a time of arrival at the destination.

23. A display apparatus for a navigation system as defined in claim 16, further comprising:
means for specifying a type of POIs (points of interest) in a neighborhood area of the destination from a POI database of the navigation system;
means for retrieving business hour information of the specified type of POIs from the POI database or from a remote service provider through a wireless communication;
means for comparing the ETA at the destination and the business hour information of the POIs; and
means for listing the specified type of POIs sorted by distance from a reference location or the destination wherein each POI in the list is accompanied by an estimated remaining business hour at a time of arrival at the destination.

24. A display apparatus for a navigation system as defined in claim 23, wherein the estimated remaining business hours of the POIs in the neighborhood area of the destination are classified and displayed by availability icons using predetermined shapes or colors.

25. A display apparatus for a navigation system as defined in claim 16, further comprising:
means for specifying a type of POIs (points of interest) in a neighborhood area of the destination from a POI database of the navigation system;
means for retrieving business hour information of the specified type of POIs from the POI database or from a remote service provider through a wireless communication;
means for comparing the ETA at the destination and the business hour information of the POIs; and
means for listing the specified type of POIs in the neighborhood area of the destination sorted by degrees of remaining business hour at a time of arrival at the destination.

26. A display apparatus for a navigation system as defined in claim 25, wherein the degrees of remaining business hours of the POIs in the neighborhood area of the destination are classified and displayed by time length icons using predetermined shapes or colors.

27. A display apparatus for a navigation system as defined in claim 16, further comprising means for indicating a change of time zone when the current position is at a border or near the boarder of two or more different time zones.

28. A display apparatus for a navigation system as defined in claim 27, wherein said means for indicating the time zone change includes means for displaying the time zone change on a screen, or both displaying and voice announcing the time zone change.

29. A display apparatus for a navigation system as defined in claim 27, wherein said means for indicating the time zone change is conducted without regard to whether the navigation system is in a route guidance mode for guiding the user to the destination or a mode other than the route guidance mode.

30. A display apparatus for a navigation system as defined in claim 16, wherein said step of calculating the ETA includes the steps of:
means for calculating the ETA based on a local time at the destination if the destination belongs to a time zone different from the time zone at the current user position;
means for calculating the ETA based on a local time at the current user position if the destination belongs to the same time zone as the time zone at the current user position; and
means for compensating the ETA for a difference of daylight saving time when the daylight saving time is applied to either the destination or the current user position.
